(19) United States
(12) Patent Application Publication
(10) Pub. No.: US 2009/0192987 A1
(43) Pub. Date: Jul. 30, 2009

(54) SEARCHING NAVIGATIONAL PAGES IN AN INTRANET

(75) Inventors: Alexander Loeser, Berlin (DE); Sriram Raghavan, San Jose, CA (US); Shivakumar Vaithyanathan, San Jose, CA (US); Huaiyu Zhu, Union City, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/022,777

(22) Filed: Jan. 30, 2008

(51) Int. Cl. G06F 17/30

(52) U.S. Cl. 707/3; 707/E17.017

(57) ABSTRACT

Exemplary embodiments of the present invention relate to a method for searching navigational pages within an intranet environment. The method comprises identifying a plurality of navigational pages, performing a page-level analysis upon each identified navigational page in order to determine if a navigational page can be categorized as a candidate navigational page, performing a cross-page analysis upon each determined candidate navigational page in order to generate a final set of navigational pages, associating each final navigational page with a predetermined semantic classification group, generating term variants for each navigational page, building a navigational index for each semantic classification grouping, and filtering user queries in association with a user profile of a user that is posing a query.

### BACKGROUND OF THE INVENTION

1. Field of the Invention

This invention relates to the performance of query searches, and particularly to navigational query results in an intranet environment.

2. Description of Background

The ultimate goal of any search system is to answer the need behind the query, as such, queries on an intranet can be classified as informational, navigational or transactional. Web-search engines routinely answer navigational queries. For instance, if the user query is the name of a person, then the top-ranked results from most search engine are predominantly user homepages. Unfortunately, this does not imply that a navigational search in an intranet is a solved problem. Further, despite the success of web search engines, search over large enterprise intranets still suffers from poor result quality.

### SUMMARY OF THE INVENTION

The shortcomings of the prior art are overcome and additional advantages are provided through the provision of a method for searching navigational pages within an intranet environment. The method comprises identifying a plurality of navigational pages, performing a page-level analysis upon each identified navigational page in order to determine if a navigational page can be categorized as a candidate navigational page, performing a cross-page analysis upon each determined candidate navigational page in order to generate a final set of navigational pages, associating each final navigational page with a predetermined semantic classification group, building a navigational index for each semantic classification grouping, and filtering the results of user queries in association with a user profile of a user that is posing a query.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWING

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram for a method for recognizing navigational pages within an intranet.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention provide a solution comprising an offline process in which all navigational pages that are available within an intranet are recognized and each page is associated with an appropriate term variants. Further, the navigational pages—depending on the sequence of analysis steps that have been used to identify them—are placed into one of several semantic classification groupings or “semantic buckets” (e.g., there is a semantic bucket that is associated with all of the personal home pages). For each semantic bucket a standard inverted index is built using the terms and term variants that are associated with the set of navigational pages that are comprised within the bucket (this index is referred to as a navigational index). At runtime, a given search query is executed on all these navigational indices and the results are merged to produce the final answer to the navigational query.

The concentration of the present solution is based on the off-line identification of navigational pages, generation of term-variants to associate with each page, and the construction of separate indices exclusively devoted to answering navigational queries. A further implemented procedure relates to the usage of a procedure for the identification of navigational pages using a sequence of local (i.e., intra-page) and global (i.e., cross-page) analysis procedures. Yet further, the problem of filtering and ranking the results of navigational queries based on user profiles is addressed. In this context, a technique solution for answering geo-sensitive navigational queries is presented (i.e., queries for which the correct result page depends on the geography of the user posing the query).

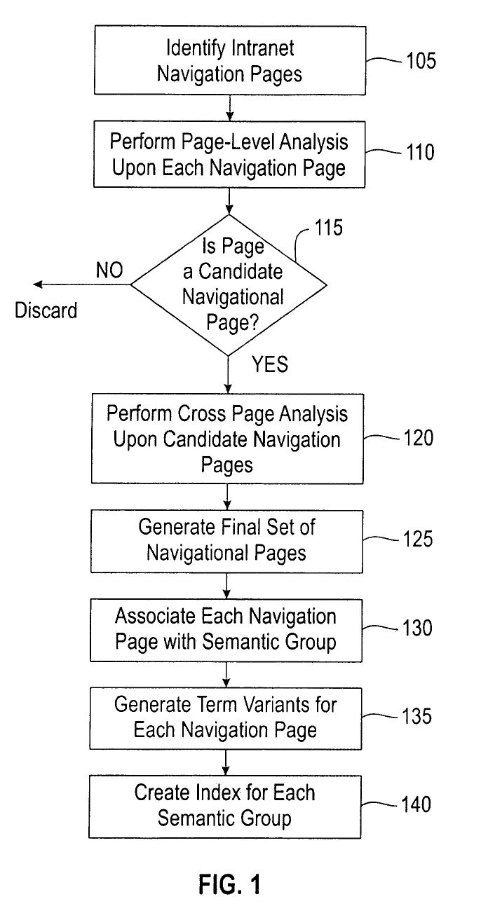

As shown in FIG. 1, the first steps in answering navigational queries are identifying the available intranet navigational pages (steps 110-125). As such, the present strategy for identifying such pages consists of two phases of analysis; a local analysis is the first phase and a global analysis in a second phase. In regard to a local (or page-level) analysis each navigation page is individually analyzed (step 110) to extract clues that help decide whether that page can serve as a “candidate navigational page.” Navigational pages that are determined as being able to serve as candidate navigational pages are further analyzed while remaining candidate navigation pages are discarded as potential candidates (step 115).

Regarding the local analysis of phase one, it is sufficient to restrict attention to specific attributes of a navigational page. In general it is determined that a small but specific set of attributes are sufficient indicators of a navigational page. Such attributes are referred to as “navigational features.” Examples of such features are title and URL. For instance, the presence of phrases such as “home,” “intranet,” or “home page,” in the title or an URL ending in “index.html” or “home.html,” serve as strong indicators that the corresponding navigational page is a candidate navigational page. The candidate pages go into the candidate navigation page listing (step 115).

An operational procedure included within the local analysis is the feature extraction operation in which one or more navigational page features are extracted from an input navigational page. These navigational features are then fed into a sequence of pattern matching steps. Each pattern matching step either involves the use of regular expressions or an external dictionary (e.g., such as a dictionary of person names or product names). Depending on the output of the final pattern matching step, the local analysis algorithm will decide whether a given page is a “candidate navigational page” and optionally associate a “feature value” with each output candidate (step 130).

Further, domain dictionaries can yield significant benefits, such as acronyms and employee directories can dramatically improve precision. Acronyms, for example, proliferate throughout a modern enterprise as they are used to compactly name everything from job descriptions to company locations and business processes.

The local analysis algorithms presented in the first phase rely on the recognition of patterns in page level features such as the title or URL of a navigational page. While page-level cues yield candidate navigational pages, they also include a number of false positives. Given multiple pages with similar URLs/titles that match these patterns, the local analysis procedure will recognize all of these pages as candidate navigational pages and assign identical feature values to each page. In order to filter out spurious navigational pages from the output of local analysis a global analysis procedure referred to as site root analysis is implemented to exploit the hierarchical structure inherent in groups of related pages to in order to identify root navigational pages.

Certain navigational pages may not have obvious features to put them in the pool of candidate navigational pages, yet they still can be recognized as such from factor that other pages link to them with cues indicating that the page being pointed to is navigation page. These pages are also considered as candidate navigational pages. Another global analysis procedure, referred to as anchor analysis, extracts feature values for these pages utilizing anchor texts of links to these pages from other pages.

In regard to the global analysis of the second phase, in the site root analysis procedure, groups of candidate navigational pages are further examined (step 120) in order to weed out false positives and generate the final set of navigational pages. Pages with similar navigational feature values are grouped together according to page hierarchies provide with these feature values. Within each group, pages are arranged in a forest according to their URL hierarchy. Certain pages are marked as definite navigational pages, according to their strong features. The subtrees of these nodes are removed. The remaining roots of the trees in the forest are considered as site root pages. These pages go into the final navigation page listing (step 125).

In regard to the global analysis of the second phase, in the anchor text analysis procedure, groups of pages that point to the same target page with navigational cues are analyzed together. Within such a group, the feature value extracted from anchor texts for the link may be different. These feature values are divided into similarity groups. The similarity may be defined by transforming them into canonical forms and compare the identity of the canonical forms. The feature values of the largest group is taken as the feature value of the navigational page. Other criteria may be used, such as retaining feature values from all groups with sizes above a threshold.

Within exemplary embodiments of the present invention a navigational index is created to exploit the results of local and global analysis in order to answer navigational queries with significantly higher precision than a generic search index (step 140). There are two steps in this process: semantic term-variant generation (step 135) and indexing (step 140). As described above, the conclusion of the local and global analysis results in the accrual of multiple collections of navigational pages collectively referred to as semantic buckets. Further, associated with each navigation page in each bucket is a feature value (e.g., a person name, a phrase in the title, a segment of a URL, etc.), wherein each semantic bucket reflects the underlying analysis step that was responsible for placing a particular page in that bucket.

For each navigational page, a set of query term variants are generated that may match user query (step 135). This procedure makes use the specificity of the semantic buckets. For example, for the semantic buckets of a person's name, the procedure will generate the common variants of a given person's name. Other variant generators can be defined based on the underlying semantics of the buckets.

Once the appropriate variant generator has been applied to the feature values in each semantic bucket, the indexing process is straightforward. For each bucket, we build a corresponding inverted index in which the index terms associated with a page are derived exclusively from the navigational feature values and associated variants. None of the terms from the original text of a navigation page are included within the index. Thus the resulting inverted index is a pure “navigational index” that will provide answers only when user queries match navigational feature values or their variants.

Within additional exemplary embodiments of the present invention, given a search query with an associated user profile, certain attributes of the user profile are utilized to obtain a more efficient query result (e.g., such as work location and job description, etc.) in order to further filter or rank the results from the navigational search index. Within exemplary aspects of the present invention the geographic location of the poser of a query is taken into consideration when compiling the results of a query request. These further analysis procedures comprise geo-tagging, geo-sensitivity, and geo-filtering analysis. Geo-tagging is a local analysis step in which each intranet page is individually analyzed and tagged with the names of one or more countries and regions. Geo-sensitivity analysis is an analysis procedure wherein the geography tags for all the pages with a given navigational feature value are examined to conclude whether queries matching that value are geography-sensitive. Geo-filtering further comprises a runtime filtering analysis in which the results for queries that are judged to be geography-sensitive are filtered to include only the pages from the geography where the user is located. An implementation can also rank the results according to the user geography location. It may also allow the user to choose a different geography location.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for searching navigational pages within an intranet environment, the method comprising:
identifying a plurality of navigational pages within the intranet environment;
identifying candidate navigational pages from the plurality of navigational pages by performing a page-level analysis upon each of the plurality of pages;
identifying additional candidate navigational pages from the plurality of navigational pages by performing an anchor text analysis to extract feature values utilizing anchor texts of links to the additional navigational pages from the plurality of navigational pages;
generating a final set of navigational pages by performing a cross-page analysis upon each of the candidate navigational pages and the additional candidate navigational pages, the cross-page analysis removing false positive identifications within the candidate navigational pages;
associating each of the final set of navigational pages with at least one predetermined semantic classification group, the at least one predetermined semantic classification group including terms associated with the final set of navigational pages;
generating term variants for each of the terms in the at least one semantic classification group, the term variants providing variations of the terms in the at least one semantic classification group;
building a navigational index for the at least one semantic classification group;
filtering results of user queries associated with a user profile of a user that is posing a query; and
filtering the user queries using geographic location information associated with a user that is posing the query.

2. (canceled)

3. The method of claim 1, wherein performing the anchor analysis comprises forming similarity groups within the additional candidate navigational pages.

4. The method of claim 3, wherein forming the similarity groups includes transforming the feature values into canonical forms.

5. The method of claim 4, further comprising:
identifying a similarity group containing more feature values than others of the similarity groups; and
designating the feature value in the similarity group containing more feature values that others of the similarity groups as the feature value of the navigational page.

6. The method of claim 1, further comprising:
identifying geography tags for each of the plurality of navigational pages having a particular feature value.

7. The method of claim 6, further comprising: filtering user queries based on the geography tags to identify geography-sensitive queries.

8. The method of claim 7, further comprising: filtering the geography-sensitive queries to only include select ones of the plurality of navigational pages at the user's location.
